(19) United States
(12) Patent Application Publication
(10) Pub. No.: US 2014/0013193 A1
(43) Pub. Date: Jan. 9, 2014

(54) METHODS AND SYSTEMS FOR CAPTURING INFORMATION-ENHANCED IMAGES

(71) Applicants: Joseph John Selinger, Chicago, IL (US); David Jeffrey Greene, Chicago, IL (US)

(72) Inventors: Joseph John Selinger, Chicago, IL (US); David Jeffrey Greene, Chicago, IL (US)

(21) Appl. No.: 13/931,778

(22) Filed: Jun. 28, 2013

Related U.S. Application Data
(60) Provisional application No. 61/666,032, filed on Jun. 29, 2012.

(51) Int. Cl. G06F 17/21

(52) U.S. Cl. CPC G06F 17/212
USPC 715/203

(57) ABSTRACT

The approaches of the present disclosure provide for the efficient technology of intelligent association of still images with contextual information relating to sounds such as a sound that may have been ambient when a still image was captured. In particular, a user may use a media device, such as a smart phone or tablet computer, to capture a still image and record first audio, for example, at the time of capturing the still image for a predetermined period of time. The first audio may be then processed and analyzed so as to recognize a particular song or melody, and then a high quality second audio related to the recognized song or melody is downloaded and associated with the still image. Accordingly, the visual nature of still images is enhanced with data relating to contextual auditory information, which boosts the sensory and memory experience for the user.

### CROSS-REFERENCE TO RELATED APPLICATIONS

This application claims benefit of U.S. Provisional Patent Application Ser. No. 61/666,032, filed on Jun. 29, 2012, which is incorporated herein by reference in its entirety for all purposes.

### TECHNICAL FIELD

This disclosure relates generally to digital image and audio processing and, more particularly, to the technology for generating information-enhanced images, which associate still images with particular audio data.

### DESCRIPTION OF RELATED ART

The approaches described in this section could be pursued but are not necessarily approaches that have previously been conceived or pursued. Therefore, unless otherwise indicated, it should not be assumed that any of the approaches described in this section qualify as prior art merely by virtue of their inclusion in this section.

Today, there are many forms of media devices for capturing recordable media types such as still images. Examples of media devices include digital still cameras, video camcorders, portable computing devices, such as cellular phone or tablet computers, having embedded digital cameras, and so forth. Some of these media devices may also support recording audio.

In general, it is desirable for the users of media devices to be able to listen to audio in conjunction with a still picture in order to add another dimension to viewing the pictures later. In other words, while reviewing captured still images, the users may want to listen to sounds that may have been ambient when a specific image was captured (e.g., background music that was playing when an image was captured).

In many media devices, audio data may be captured for either a preset duration at the same time as capturing a still image or right afterward. Even though both approaches have their merits, there are disadvantages with each. In particular, the quality of audio captured may be relatively low or include noise or various unwanted sounds. Accordingly, there is a need in the art for technology that permits a user to flexibly and efficiently associate still images and audio data.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

The approaches of the present disclosure provide for the efficient technology of intelligent association of still images with contextual information relating to sounds such as a sound that may have been ambient when a still image was captured. In particular, a user may use a media device, such as a smart phone or tablet computer, to capture a still image and record first audio, for example, at the time of capturing the still image for a predetermined period of time. The first audio may be then processed and analyzed so as to recognize a particular song or melody, and then a high quality second audio related to the recognized song or melody is downloaded and associated with the still image. Accordingly, the visual nature of still images is enhanced with data relating to contextual auditory information, which boosts the sensory and memory experience for the user.

According to an aspect of the present disclosure, there is a method provided for associating media content. An example method may include receiving, by a processor, image data associated with an image captured by a camera. The method may further include receiving, by the processor, sound data associated with an audio signal captured by a microphone. The method may further include applying, by the processor, at least a portion of the sound data to a sound recognition application to automatically determine whether the sound data is representative of a known sound or melody. The method may further include associating, by the processor, the image data with data representative of the known sound or melody based on the determination.

In certain embodiments, the method may further include receiving, by the processor, audio content corresponding to the data representative of the known sound or melody, and associating, by the processor, the image, and the audio content. The method may further include presenting the associated image and audio content to a user via a graphical interface in response to a user input.

In certain embodiments, the sound recognition application may comprise a music recognition application. The method may further include applying, by the processor, at least a portion of the sound data to the music recognition application for the music recognition application to automatically determine whether the sound data is representative of a known musical composition, and in response to the music recognition application being able to reach a determination that the sound data is representative of a known musical composition, associating, by the processor, the image data with data representative of the known musical composition. The method may further include storing, in a memory, as part of a data structure, a first data object representative of the image data, and a second data object associated with the first data object, with the second data object being representative of the known musical composition.

In certain embodiments, the data representative of the known musical composition comprises a title for the known musical composition and an artist name for the known musical composition. The method may further include storing, in the memory, as part of the data structure, a plurality of the first and second data objects, with each first data object corresponding to a different image, and each second data object corresponding to a known musical composition associated with the image of its associated first data object. The method may further include posting, in a social network by the processor, the first data object and the second data object in response to a user input. The method may further include enabling, by the processor, the user to purchase a copy of the known musical composition from a music-selling application in response to a user input. The method may further include storing the purchased copy in the memory in association with the first data object.

In certain embodiments, the method may further include enabling, by the processor, the user to edit the image or the image data in response to a user input. The method may further include providing, by the processor, a graphical user interface enabling the user to capture the image with the camera, and the camera may be integrated into a portable computing device. The method may further include providing, by the processor, a graphical user interface enabling the user to capture the audio signal with a microphone, and the microphone may be integrated into a portable computing device.

In certain embodiments, the image data may include at least one file name or an identification number of the image, and the sound data may include at least one file name or an identification number of the audio signal.

According to another aspect of the present disclosure, there is a system provided for associating media content. An exemplary system may include a communication module configured to receive image data associated with an image captured by a camera, and an audio signal captured by a microphone. The system may further include a processor operatively coupled with a memory, wherein the processor is configured to run a sound recognition application to automatically determine whether the audio signal is representative of a known sound or melody based at least in a portion of the sound data. The processor may be further configured to associate the image data with data representative of the known sound or melody based on the determination that the sound data is representative of the known sound or melody.

In certain embodiments, the sound recognition application may be configured to perform identification that the audio signal is associated with the known song or melody using one or more acoustic fingerprints. Further, in certain embodiments, the sound recognition application may be further configured to apply at least a portion of the audio signal to a remote music recognition application to automatically determine whether the audio signal is representative of a known musical composition by (1) communicating at least a portion of the audio signal to the remote music recognition application via a network, and (2) receiving data from the remote music recognition application via the network, with the received data being indicative of whether the audio signal may be representative of a known musical composition.

In certain embodiments, the processor may be further configured to, in response to the remote music recognition application being unable to reach a determination that the sound data is representative of a known musical composition, (1) present a graphical user interface, which may be configured to solicit input from a user that is representative of information about the audio signal, (2) receive the solicited input via the graphical user interface, and (3) associate the image data with received solicited input. In certain embodiments, the sound recognition application may comprise a music recognition application, and the sound recognition application may be configured to (1) apply at least a portion of the audio signal to the music recognition application in order for the music recognition application to automatically determine whether the audio signal is representative of a known musical composition, and (2) in response to the music recognition application being able to reach a determination that the audio signal is representative of a known musical composition, associate the image data with data representative of the known musical composition.

In further example embodiments of the present disclosure, the method steps are stored on a machine-readable medium comprising instructions, which when implemented by one or more processors perform the recited steps. In yet further example embodiments, hardware systems, or devices can be adapted to perform the recited steps. Other features, examples, and embodiments are described below.

### BRIEF DESCRIPTION OF THE DRAWINGS

Embodiments are illustrated by way of example, and not by limitation, in the FIGS. of the accompanying drawings, in which like references indicate similar elements and in which:

FIG. 1 shows a high level diagram of an exemplary system diagram for an exemplary embodiment;

FIG. 2A shows a high level diagram of an exemplary system diagram for an exemplary portable computing device;

FIG. 2B shows a high level diagram of an exemplary mobile application for an exemplary embodiment;

FIG. 3 shows a high level diagram of an exemplary process flow for an exemplary embodiment;

FIG. 4 shows a high level diagram of an exemplary data structure for an exemplary embodiment;

FIG. 5 shows a high level diagram of an exemplary navigation flow of user interface screens, in accordance with an exemplary embodiment;

FIG. 6 shows a high level diagram of an exemplary process flow for purchasing an associated song, in accordance with an exemplary embodiment;

FIG. 7 shows a high level diagram of an exemplary data structure that can be generated in accordance with the exemplary embodiment of FIG. 6;

FIG. 8 shows a high level diagram of an exemplary process flow for another exemplary embodiment;

FIG. 9 shows a diagrammatic representation of a computing device for a machine in the example electronic form of a computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is therefore not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The techniques of the embodiments disclosed herein may be implemented using a variety of technologies. For example, the methods described herein may be implemented in software executing on a computer system or in hardware utilizing either a combination of microprocessors or other specially designed application-specific integrated circuits (ASICs), programmable logic devices, or various combinations thereof. In particular, the methods described herein may be implemented by a series of computer-executable instructions residing on a storage medium such as a disk drive or computer-readable medium. It should be noted that methods disclosed herein can be implemented by a computer (e.g., a desktop computer, tablet computer, laptop computer), game console, handheld gaming device, cellular phone, smart phone, smart television system, and so forth.

The present technology, according to multiple embodiments disclosed herein, allows for users of various media devices, such as smart phones or tablet computers, to generate media content involving still images intelligently associated of high quality audio data. In particular, the present technology may enable a user of a media device to take a picture and record an audio signal he wants associated thereto. The audio signal or at least some of its parts can be then analyzed by a sound recognition module which may identify that the audio signal is related to a particular known musical composition, song, or melody. The present technology further associates the image taken by the user, or data related to this image (e.g., file names), with data of the particular known musical composition, song, or melody. In some embodiments, the particular known musical composition, song, or melody may be downloaded and played to the user along with showing the image. Accordingly, the technology described herewith enhances the visual nature of taken still images, thereby enhances sensory and memory experience for the user.

In certain embodiments, the image(s) taken by the user and/or previously purchased/downloaded musical composition(s), song(s), or melody(ies) and/or recently identified musical composition(s), song(s), or melody(ies) and/or historical information may be further analyzed to generate recommendations or suggestions to the user. Some recommendations or suggestions may relate to other musical composition(s), song(s), or melody(ies) that may bepotentially of interest for the user. Some recommendations or suggestions may relate to additional music information including, for example, albums and/or tour dates of bands as most liked by the user (e.g., more frequently played/used in association with the images; or frequently downloaded/purchased, etc.). In an example, the user may receive suggestions for upcoming concerts, album releases and information on similar artists, links to purchase tickets of concerts, links to access detailed information regarding albums, bands, band tours, or particular musical composition(s), song(s), or melody(ies). The recommendations or suggestions may be delivered to the user via a graphical user interface as described below.

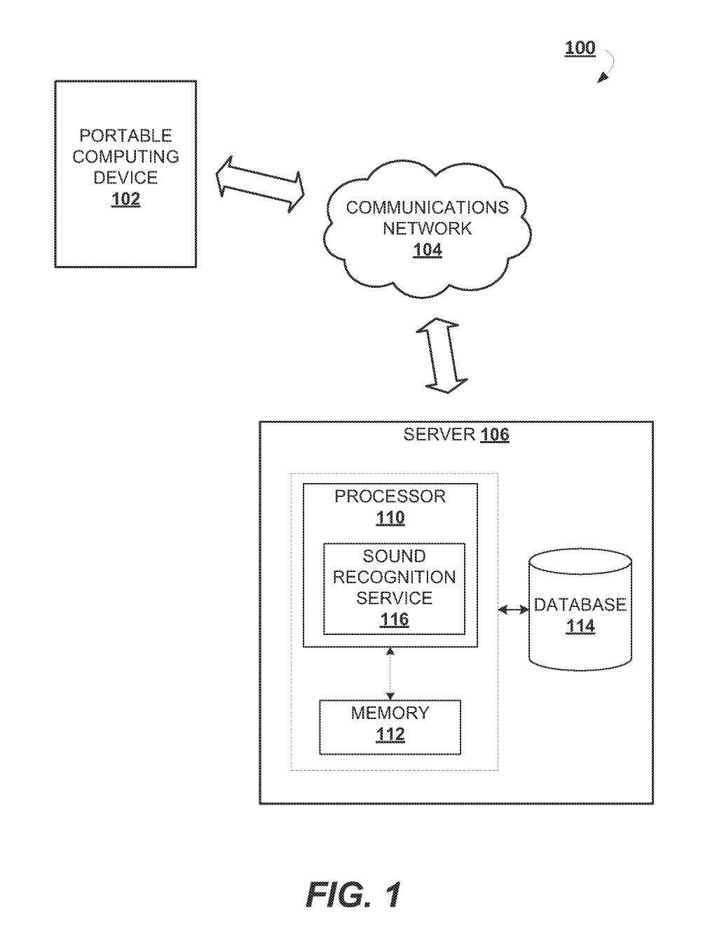

Now referring to the drawings, FIG. 1 shows a high level block diagram of an exemplary system 100 for an exemplary embodiment of the present technology suitable for intelligently creating media content. A computing device such as a portable computing device 102 can be configured for communicating with a server 106 via a communications network 104. The portable computing device 102 can take any of a number of forms, including but not limited to a computer (e.g., laptop computer, tablet computer), a mobile device (e.g., a cellular phone, smart phone, personal digital assistant (PDA)), a digital camera or video camera, and so forth. The portable computing device 102 may include an input device, such as a touchscreen, camera, microphone, and a communication module.

The network 104 can be any communications network capable of communicating data between the portable computing device 102 and the server 106. The communications network 104 can be a wireless or wire network, or a combination thereof. For example, the network may include one or more of the following: the Internet, local intranet, PAN (Personal Area Network), LAN (Local Area Network), WAN (Wide Area Network), MAN (Metropolitan Area Network), virtual private network (VPN), storage area network (SAN), frame relay connection, Advanced Intelligent Network (AIN) connection, synchronous optical network (SONET) connection, digital T1, T3, E1 or E3 line, Digital Data Service (DDS) connection, DSL (Digital Subscriber Line) connection, Ethernet connection, ISDN (Integrated Services Digital Network) line, cable modem, ATM (Asynchronous Transfer Mode) connection, or an FDDI (Fiber Distributed Data Interface) or CDDI (Copper Distributed Data Interface) connection. Furthermore, communications may also include links to any of a variety of wireless networks including, GPRS (General Packet Radio Service), GSM (Global System for Mobile Communication), CDMA (Code Division Multiple Access) or TDMA (Time Division Multiple Access), cellular phone networks, Global Positioning System (GPS), CDPD (cellular digital packet data), RIM (Research in Motion, Limited) duplex paging network, Bluetooth radio, or an IEEE 802.11-based radio frequency network.

The server 106 may include a processor 110 (or a group of processors) and associated memory 112 as well as a database 114. As described herein after, the processor 110 may be configured to execute a sound recognition service 116 in response to data received from the portable computing device 102. The server 106 may also implement a number of various functions including retrieving, purchasing and/or uploading to the portable computing device 102 or facilitating in retrieving, purchasing and/or uploading to the portable computing device 102 identified musical composition(s), song(s), or melody(ies) for further associating with the images taken by the user. The server 106 may also store the images taken by the user. The server 106 may also facilitate sharing the images and associated musical composition(s), song(s), or melody(ies) via the Internet using various social networking or blogging sites. The server 106 may also aggregate historical information of user activities, user preferences and the like. For example, the server 106 may aggregate historical information related to what musical composition(s), song(s), or melody(ies) the user likes, or plays more frequently or downloads/purchases more frequently than any other musical composition(s), song(s), or melody(ies), or associates more frequently with images, and so forth. The historical information may also include information regarding the images taken by the users, geographical information associated therewith, user friends, user social networking peers, user blogging peers, user activities, events, and many more. The server 106 may be also configured to analyse the historical information and generate recommendations or suggestions for the user. The recommendations or suggestions may refer to a wide range of information or prompts including, for example, additional music information related to albums or bands (e.g., of user liked bands), tour dates, and so forth. In certain embodiments, the server 106 may assist the user 106 in purchasing not only music, but also tickets for music shows, concerts, and so forth. In certain embodiments, suggestions or recommendations related to musical composition(s), song(s), or melody(ies) or bands that are similar to those musical composition(s), song(s), or melody(ies) that the user likes can be generated based on the analysis of historical information. The data mining algorithms which would employ use of the historical information to generate recommendations or suggestions to the user is novel because the algorithm provides information regarding which activities the user is engaged in while listening to different genres of music. The historical information includes a variety of unique information sources such as images taken by users, song title and artist name, geographical information, user friends, user social networking peers user blogging peers, user activities, events and many more. The ability to mine a database of photos based on song title and artist name, for example, will provide a unique set of data that current search engines do not provide. Those skilled in the art would appreciate that unique mining data algorithms may be employed at the server side to generate recommendations or suggestions to the user as described above.

As should be well understood by those skilled in the art, the server 106 may comprise a plurality of networked servers, and the system 100 may support communications with a plurality of the portable computing devices 102.

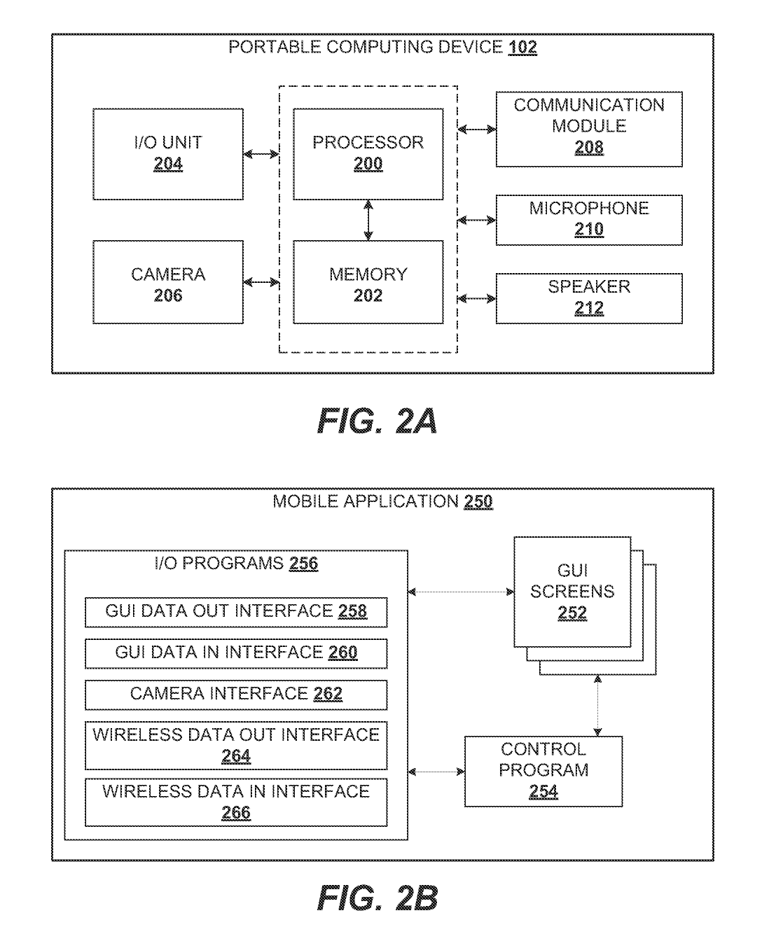

FIG. 2A shows a high level block diagram of an exemplary portable computing device 102. The portable computing device 102 may comprise a processor 200 and associated memory 202. Furthermore, the portable computing device may include an Input/Output (I/O) unit 204 (e.g., a touchscreen for presenting a graphical user interface for displaying output data and receiving input data from a user), a camera 206, a communication module 208 (e.g., a wireless communication module) for sending and receiving data (e.g., via a wireless network for making and taking telephone calls or transmitting data to the network 104), a microphone 210 for sensing sound and converting the sensed sound into an electrical audio signal that can serve as sound data, and a speaker 212 for converting sound data into audible sound. These components are now resident in many standard brands of smart phones and other portable computing devices.

FIG. 2B depicts an exemplary mobile application 250 for an exemplary embodiment of the present technology. The mobile application 250 can be installed on the portable computing device 102 for execution by the processor 200. The mobile application 250 may include a plurality of computer-executable instructions resident on a non-transitory computer-readable storage medium such as a computer memory. The instructions may include instructions defining a plurality of graphical user interface (GUI) screens for presentation to the user through the I/O unit 204. The instructions may also include instructions defining various I/O programs 256 such as a GUI data out interface 258 for interfacing with the I/O unit 204 to present one or more GUI screens 252 to the user, a GUI data in interface 260 for interfacing with the I/O unit 204 to receive user input data therefrom, a camera interface 262 for interfacing with the camera 206 to communicate instructions to the camera 206 for capturing an image in response to user input and to receive image data corresponding to a captured image from the camera 206, a wireless data out interface 264 for interfacing with the communication module 208 to provide the wireless I/O with data for communication over the network 104, and a wireless data in interface 266 for interfacing with the communication module 208 to receive data communicated over the network 104 to the portable computing device for processing by the mobile application 250.

The instructions may further include instructions defining a control program 254. The control program can be configured to provide the primary intelligence for the mobile application 250, including orchestrating the data outgoing to and incoming from the I/O programs 256 (e.g., determining which GUI screens 252 are to be presented to the user).

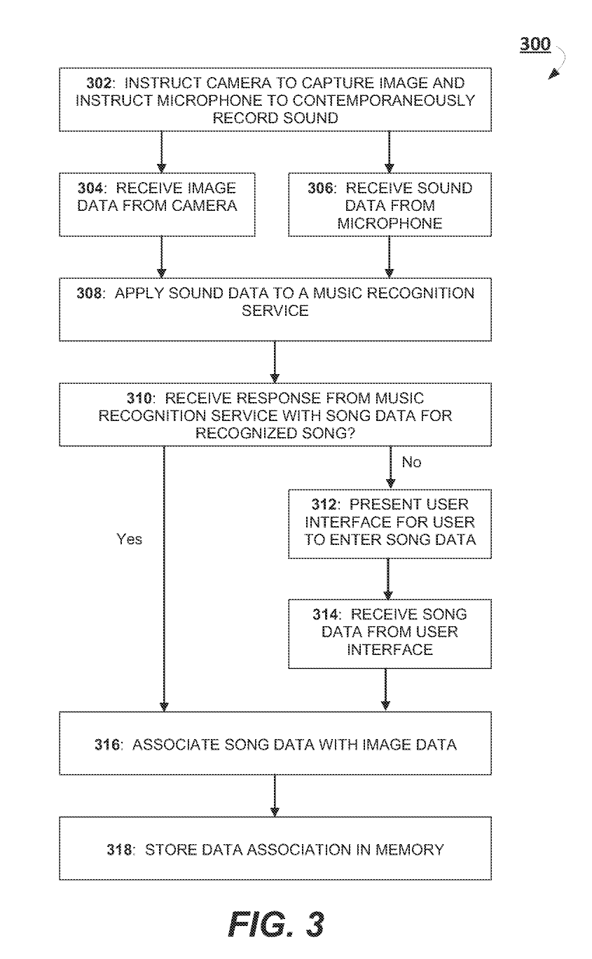

FIG. 3 shows a block diagram of an exemplary process flow of method 300 for creating media content involving associating image and audio data, according to various exemplary embodiments. The method 300 may be performed by processing logic that may comprise hardware (e.g., decision making logic, dedicated logic, programmable logic, and microcode), software (such as software run on a general-purpose computer system or a dedicated machine), or a combination of both. In one example embodiment, the method 300 may be executed by the processor 200 via the control program 254 in conjunction with the other elements of the mobile application 250.

The method 300 may commence at operation 302 with the processor 200 instructing the camera 206 to capture an image and also instructing the microphone 210 to contemporaneously record a sound. In certain embodiments, however, the sound can be recorded independently of the time when the image is taken. The captured image can be a photograph or a video, and it can be taken using standard camera technology. The sound recording with the capturing of the image can be a simultaneous activity (e.g., sound starts being recorded at the same time the image is captured) or can be a near-simultaneous activity (e.g., sound starts being recorded within approximately 5 seconds of the image being captured). For example, upon initial execution of the mobile application 250, the processor 200 preferably activates the camera 206 to result in the user interface of the portable computing device 102 presenting an effective viewfinder for the camera that permits the user to align the camera for a desired image capture. The mobile application 250 can be configured such that the microphone 210 starts capturing sound around the time that the viewfinder is active. As another example, the mobile application 250 can be configured such that the trigger for the microphone 210 to start capturing sound is the user providing a corresponding input for the camera 206 to capture the image. The duration of the sound recording activity can be configurable under control of the control program 254. This duration is preferably of a sufficient length to provide enough sound data for the sound recognition service described below to recognize the recorded sound. An estimated amount of time needed for song recognition can depend on variables including, but not limited to, the volume of the ambient song and the volume of the background noise interference (e.g., people talking, general ambient noise, etc.). A range of 2-8 seconds can serve as an initial estimate, but it is expected that a practitioner can optimize this duration with routine experience.

At operation 304, the processor 200 receives image data from the camera, and preferably stores the image data in a data structure within a memory. This image data can take any of a number of forms such as jpeg data (for a photograph) or mpeg data (for a video). In certain embodiments, the image data may include just an identification number or file name of an already taken and stored image. At operation 306, the processor 200 receives sound data from the microphone 210, and preferably stores the sound data in a data structure within the memory 202. This sound data can also take any of a number of forms such as mp3-encoded data, wmv-encoded data, aac-encoded data, and so forth. In certain embodiments, the sound data may include an identification number or file name of already captured and stored audio signal. Once again, the duration of the sound data is preferably of a sufficient length to provide enough sound data for the sound recognition service described below to recognize the recorded sound.

At operation 308, the processor 200 applies the sound data to a music recognition service. Operation 308 can be automatically performed upon completion of steps 302-306, or it can be performed in response to a user input upon completion of steps 302-306, depending upon the desires of a practitioner.

While the example of FIG. 3 uses a music recognition service, it should be understood that the recognition service can be configured to recognize sounds other than music. As shown in the exemplary embodiment of FIG. 1, such a recognition service can be resident on and executed by a remote server 106. An example of a music recognition service that can be accessed for this purpose is a service involving the use of acoustic fingerprinting. It should be understood that any suitable acoustic fingerprinting technology can be utilized for sound identification, speech identification, music identification, song identification, and so forth. In certain embodiments, the acoustic fingerprinting technology may utilize neural network algorithms or any other suitable machine learning mechanisms. Some music recognition services may be accessible via an application programming interface (API). In such an embodiment, operation 308 can include the processor 200 communicating the sound data to the remote server 106 via the network 104. The processor 110 then executes the music recognition service to process the communicated sound data against a database 114 of known musical compositions (e.g., songs and melodies) to determine whether a known musical composition is recognized for the communicated sound data. If a musical composition is recognized from the sound data, the server 106 returns data about the recognized musical composition to the portable computing device 102 via the communications network 104. If the music recognition service is unable to recognize a musical composition from the sound data, the server 106 communicates such to the portable computing device 102 via the communications network 104. While the exemplary embodiment of FIG. 1 shows that the music recognition service is remote from the portable computing device, it should be understood that the music recognition service could be resident in whole or in part on the portable computing device 102 if desired by a practitioner.

At operation 310, the processor 200 may receive a response from the music recognition service. If this response includes data about a recognized musical composition, then the processor branches to operation 316. Examples of data returned by the music recognition service can be metadata about the musical composition such as a song name, artist name, album name (if applicable), and the like. At operation 316, the processor 200 then may create a data association between the image data and the metadata returned by the music recognition service. In doing so, the mobile application 250 ties the image to data about the ambient sound that was present when the image was captured, thereby providing a new type of metadata-enhanced image. At operation 318, the processor 200 may store the newly created media data association in memory.

If the response at operation 310 indicates that the music recognition service was unable to recognize a musical composition from the sound data, the processor branches to step 312 to begin the process of permitting the user to directly enter metadata about the sound data. At operation 312, the processor 200 presents a GUI to the user that is configured to solicit the user for such metadata. For example, the user interface can be configured with fields for user input of a song title, artist name, and so forth. At operation 314, the processor 200 receives the sound metadata from the user via the user interface. Thereafter, the processor 200 proceeds to operations 316 and 318 as described above.

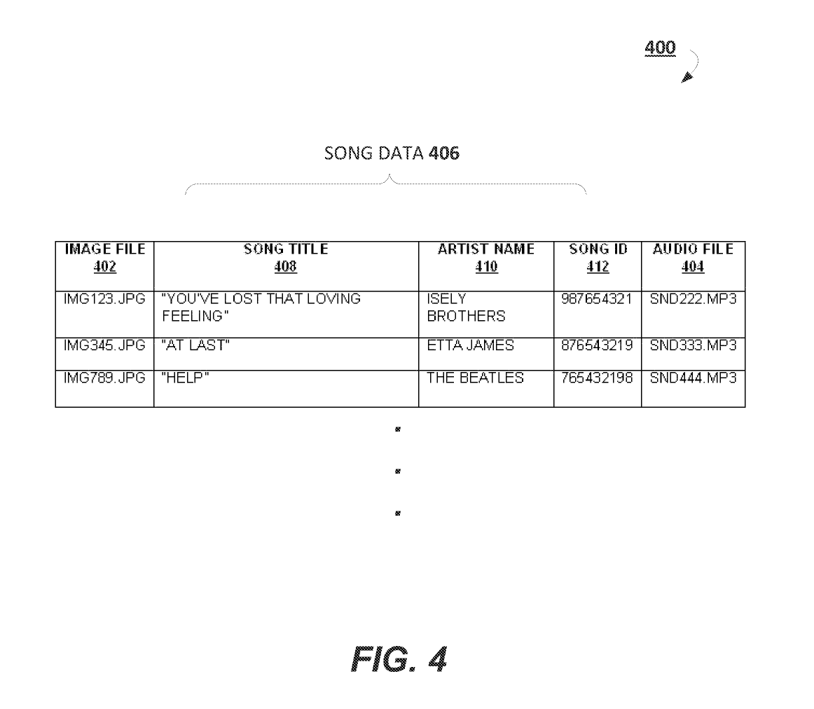

FIG. 4 depicts an exemplary data structure 400 that can be stored in a memory as a result of executing the process flow of FIG. 3. The data structure 400 may comprise a plurality of image files 402. Each image file can be associated with an audio file 404 corresponding to the sound data that was recorded at operation 306. Furthermore, each image file 402 can be associated with the metadata received at operations 310 or 314 (e.g., song data 406 such as song title 408, an artist name 410 and a song identifier 412 (which can be used to uniquely identify the song with a music selling service)). As a user continues to use the mobile application 250 to capture additional sound metadata-enhanced images, it is expected that data structure 400 will be populated with multiple image files and related information, as shown in FIG. 4.

The data structure 400 of FIG. 4 can be resident on memory 202 within the portable computing device 102, or it can be resident on memory remote from the portable computing device 102 such as a cloud storage service used by the portable computing device. Further still, it should be understood that the data structure 400 can be distributed among such local and remote memories.

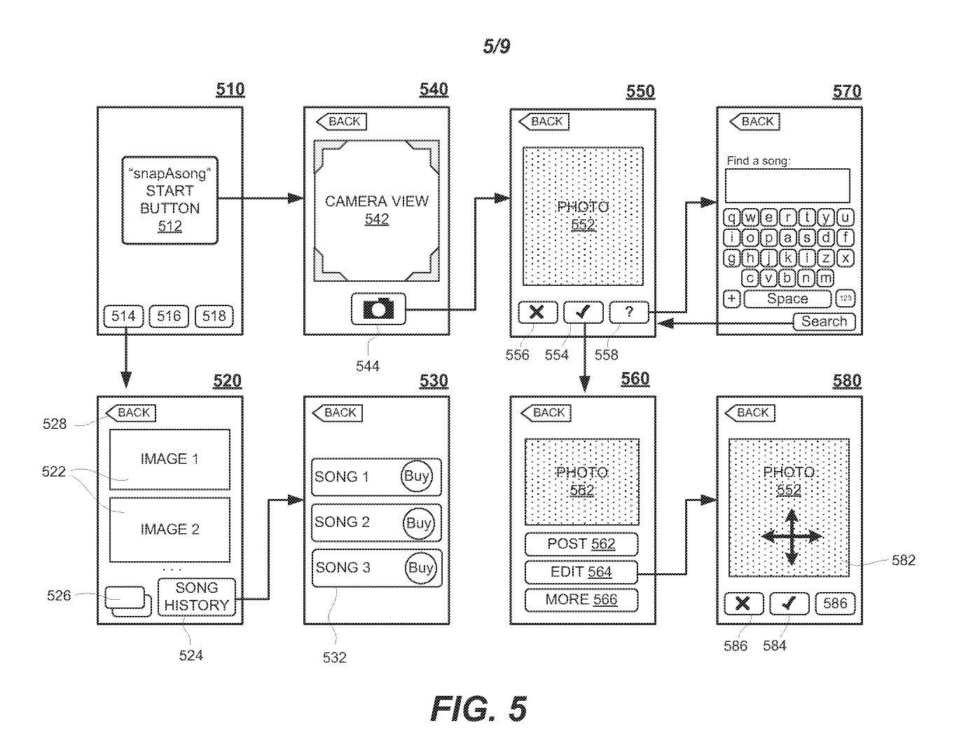

FIG. 5 depicts an exemplary navigation flow of user interface screens, in accordance with an exemplary embodiment. The interface screens 510-580 may be presented via one or more GUIs of the portable computing device 102.

The screen 510 in FIG. 5 is an exemplary home screen page in which a user will first initiate the mobile application 250. The home screen 510 may include a logo for the mobile application and identify the name of the mobile application (e.g., “snapAsong”). From the home screen, the user can be provided with a user-selectable button 512 for taking actions such as taking pictures, a user-selectable button 514 for viewing previous pictures (snaps), a user-selectable button 516 for going to a social network corresponding to the mobile application, and a user-selectable button 518 for viewing settings or accessing an information page.

Screen 520 in FIG. 5 is an exemplary screen for the user to view previous images (“MySnaps”), which can be activated by actuating the button 514. The user will have the option to view the images as thumbnails or as a list of individual images 522. The screen can also be configured to display text that identifies at least a portion of the sound metadata associated with the image (e.g., the song title of the associated song). The user will also have access to a song history (e.g., a list of the songs associated with the images (as opposed to thumbnails or a list of the images)) by actuating a button 524, and an option to upload images to a network by actuating one of buttons 526. There is also a “back” button 528 allowing the user to return to a previous screen. In certain embodiments, one of the buttons 526 may be used to lead the user to a new screen (not shown) having various suggestions or recommendations such as additional musical information, tour dates, similar music compositions that may be liked by the user, and buttons to purchase/download similar music compositions or tickets to concerts.

Screen 530 in FIG. 5 shows an exemplary screen that lists the song history of songs that are associated with the images. This screen can be presented to the user in response to the actuation of the button 524. Metadata such as album cover artwork, song title, and artist name can be presented to user in trays 532. This screen may also be configured with a user-selectable option to purchase a copy of the referenced song (see “Buy” button). Furthermore, the user can be provided with access to the camera feature from this screen as well.

Screen 540 in FIG. 5 shows a camera view user interface screen 542. This screen can include conventional smart phone camera controls (not shown) such as flip view, use flash, access previous photo, switch between photographs and video, capture the image, and so forth. As described in connection with FIG. 3, when the user presses an action button 544 to capture an image, the mobile application can also activate the microphone to capture the ambient sound including any background music.

After the user has pressed the button 544 to capture an image, screen 550 of FIG. 5 is displayed. The screen 550 displays the image (photo) 552 that was just captured. If the user is unhappy with the image, he/she can select the delete button 556 to delete the image. Furthermore, as described in connection in FIG. 3, the mobile application can be configured to automatically check the music recognition service to determine if the recorded sound can be matched to a known song. If the music recognition service was able to recognize the song, the song information (e.g., song title and artist name) can be overlaid on the image or otherwise presented on the screen. If the music recognition service was unable to recognize the song, the “Did not recognize song” button 558 can be highlighted (e.g., change colors). Similarly, the button 558 can be pressed if the user wishes to override the automatically recognized song data. If the user wants to accept the image with the automatically recognized song data, the user can select the checkbox button 554.

Selection of the button 558 will cause Screen 570 of FIG. 5 to be presented. Screen 570 can be configured to solicit the user for song data (e.g., song title and artist name). A keyboard to type information on the photo can be available to user. Once the user has typed the information, the user can accept the text by pressing the “Search” button (which will be part of the keyboard), which will direct the user back to Screen 550, where the user can take a final look of the song title and artist name that was just entered.

Selection of the checkbox button 554 will cause Screen 560 of FIG. 5 to be presented. Screen 560 can be configured to permit the user to post the image/song to a social network as described (via selection of the “Post” button 562). Screen 560 can also be configured to permit the user to edit the image (via selection of the “Edit” button 564). Another option on Screen 560 can be a button 566 for returning to Screen 540 to capture another image/song.

Screen 580 of FIG. 5 depicts an exemplary screen for editing an image 552. Any known photo editing functions 582 can be provided to the user. Examples of editing functions that can be employed include: rotating the picture, auto-quick fix (automated adjustments brightness, contrast, etc.), red eye removal, and cropping. The user can also be provided with a capability to select to drag or rotate (with their finger) the “song/artist-text,” so he/she may place it on the photo, anywhere and/or in whatever direction he/she wishes. Additional options for this can include changing fonts and colors for the text. There may be provided a “Delete/Reject” button 586, “Accept” button 584, and a button 586 providing access to other options.

Thus, through at least the screens 510-580 of FIG. 5, the mobile application described in connection with FIGS. 1-4 can be configured to not only capture images but also enhance those images with song metadata corresponding to background music that was playing when the images were captured. For example, when taking a picture of a bride and groom dancing at a wedding, the mobile application can automatically determine the name and artist for the song that was playing during the dance and enhance the image with such information.

Those skilled in the art should understand that there may be other screens (not shown) such as a network page that provides the user with access to a network through which the user can interact with other people by sharing images and songs. Through this screen, the user may have ability to create/view/edit a user profile (as well as access the camera). The accessed network can be a social network (e.g., the “snapAsong” social network) that will allow a community of users to quickly and seamlessly upload, share, and view their song-enhanced images (e.g., “snaps”) with others.

There may be provided a screen (not shown) to access a user profile, where the user can define permissions that govern the extent of privacy accorded to the user's information and images/songs. For example, the user can be given the ability to restrict viewability of the user's profile to just “friends” (as defined by the social network) or everyone. Further still, the user will be provided with an ability to restrict viewability of the user's images/songs to just “friends,” everyone, or no one (and optionally, the user can be given the ability to control these permissions on an image/song-by-image/song basis). As another feature, users can be given the ability to identify other users they wish to “follow” to stay up to date on that user's latest developments. Thus, these permissions can be another aspect of the data structure that includes the images and songs to define how the images and songs can be shared via a social network.

There may be provided a screen (not shown) with a chronological display of the images/songs of the other users whom that user has chosen to “follow.” Through the interface, the user can be provided with the capability to view and comment on those images/songs (e.g., a “like”/“don't like” feature).

There may be provided a screen (not shown) with a display, preferably via thumbnails, of the most popular/trending images/songs from social network users. There may be provided a screen (not shown) including a display of updates of a user's followers as well as being able to select news pertaining to the user's profile. An example would be for a user to see who has recently followed them or who has recently “liked” or commented on that user's images/songs. There may be provided a screen (not shown) including a settings screen where the user can edit features such as: Find Friends (the user may select to find friends on other social networks from his/her smart phone's contact list), Invite Friends (the user may invite friends to the social network from his/her contracts or those friends found via the Find Friends feature), Search “snapAsong” (the user may initiate a search on a social network to identify other users on the social network who match information on the user's contact list), Your snaps (the user can view a list of his/her images/songs), Snaps you've liked (the user can view a list of other user's images/songs that the user has provided a “like” comment for), and Edit Profile (the user can edit profile elements such as name, user name, website address, biographical information, contact information, gender, birthday, and push notification preferences). An example of a notification type can include: notifications when someone has commented on that user's images/songs (e.g., tell me when someone “likes” or “doesn't like” one of my images/songs). The notification settings can be switched between “off,” “always,” or “only from friends” in response to user input. Furthermore, the email addresses in the user profiles can be used for the purposes of emailing images/songs to each other, via conventional email or a snapAsong social network email system. Chat sessions can also be made available. The settings screen where user can edit features may also include: Visual settings (the user can adjust visual settings such the location, font and color of song title and artist name on an image), Edit shared settings (the user can define the destinations for his/her images/songs when the user selects a “Post” option to share an image/song to a social network), Change profile picture (the user can change his/her profile picture, including selecting from among a list of the user's previous images/songs or uploading an image from his/her smartphone), and so forth. The settings screen(s) can also be configured to permit the user to choose whether his/her home screen or the default home screen described above in connection with Screen 510 will be their profile page. The settings screen(s) can also be configured to permit the user to define the default privacy settings for his/her images/songs.

It should be understood that the screens of FIG. 5 are exemplary only and that more, fewer, or different screens can be used by a practitioner if desired.

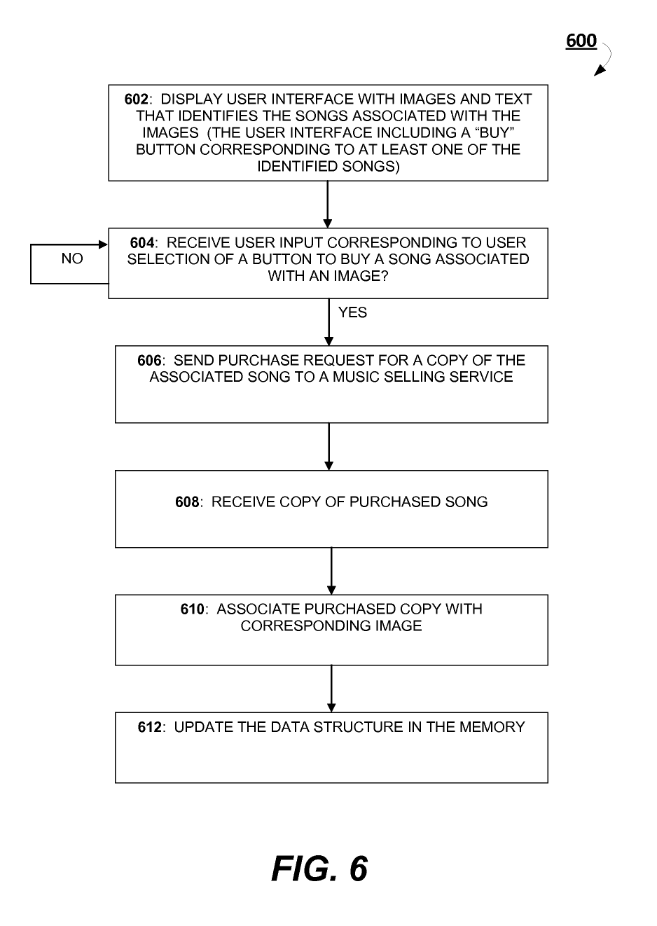

In accordance with another exemplary embodiment, the mobile application can leverage the image/song data to provide the user with an ability to purchase copies of the associated songs. An example of such an embodiment was described above in connection with Screen 530 of FIG. 5. In this regard, FIG. 6 depicts an exemplary process flow of a method 600 for purchasing an associated song in accordance with an exemplary embodiment.

At operation 602, the processor 200 presents a user interface screen, where this user interface screen identifies the songs associated with the images in the data structure 400. This user interface screen preferably displays these songs in context by also displaying their corresponding images (or portions thereof). The user interface can also include a user-selectable “buy” option with the identified songs.

At operation 604, the processor 200 checks to see if user input has been received corresponding to a selection of the “buy” option for a song. If the “buy” button is selected, the processor 200 proceeds to operation 606 and sends a purchase request for a copy of the song to a music selling service. The user profile may optionally include the user's username and password settings for the music selling service to facilitate this process.

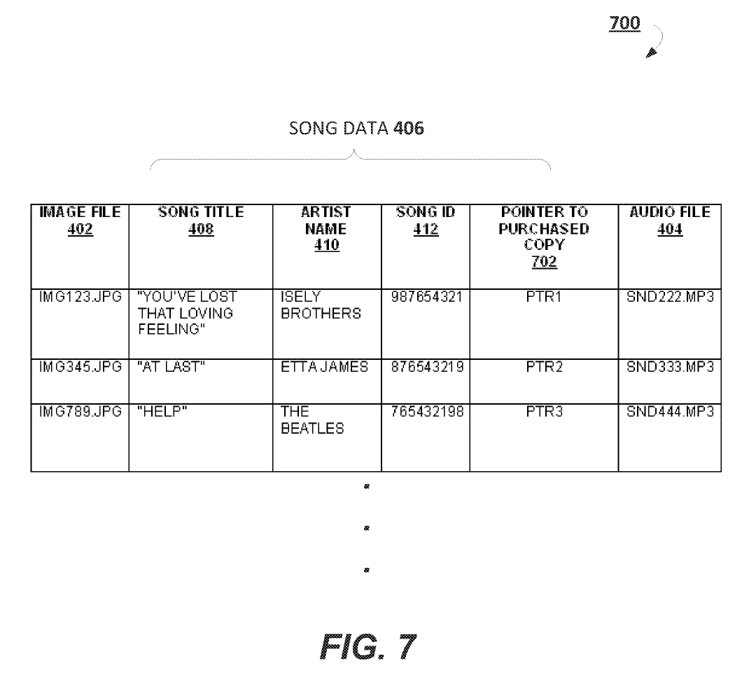

At operation 608, the processor 200 receives a copy of the purchased song from the music selling service. At operation 610, the purchased copy is associated with the image corresponding to that song, and the data structure 400 is updated at operation 612 (see pointer field 702 in the data structure 700 of FIG. 7). With this association, the display screens for the images/songs can also include a user-selectable “Play” option that will cause the portable computing device to play the song associated with an image (preferably while the image is displayed).

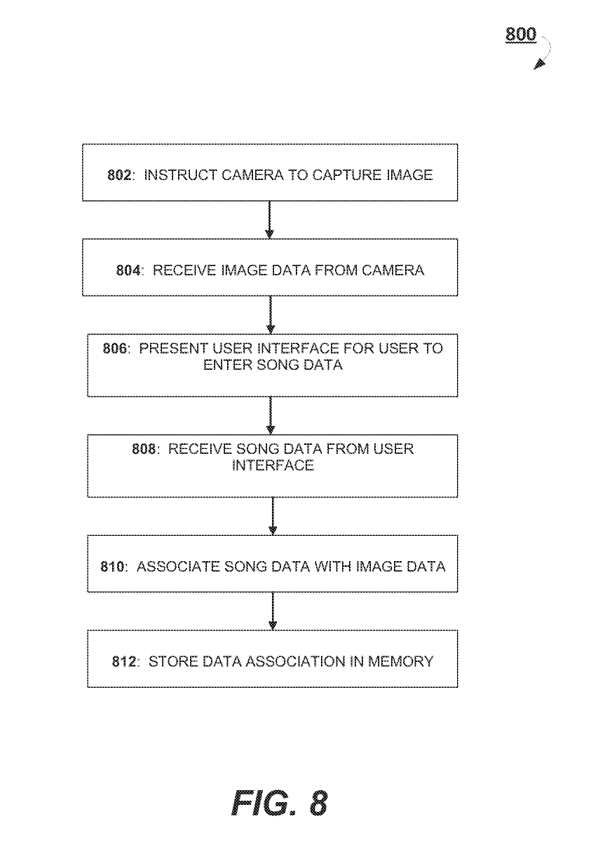

FIG. 8 depicts an exemplary process flow for a method 800 for creating associated media content, according to yet another exemplary embodiment. With this embodiment, a music recognition service need not be employed. Instead, a user can directly annotate a captured image with sound metadata. Thus, at operation 802, the processor 200 would instruct the camera 206 to capture an image in response to user input. At operation 804, the processor 200 would receive the image data from the camera 206 and a user interface would be presented to the user at operation 806. This user interface would be configured to solicit sound metadata from the user (see, for example Screen 570 of FIG. 5). At operation 808, the processor 200 receives the user-entered song data. At operation 810, the processor 200 associates the user-entered song data with the image data and stores this data association in the data structure 400.

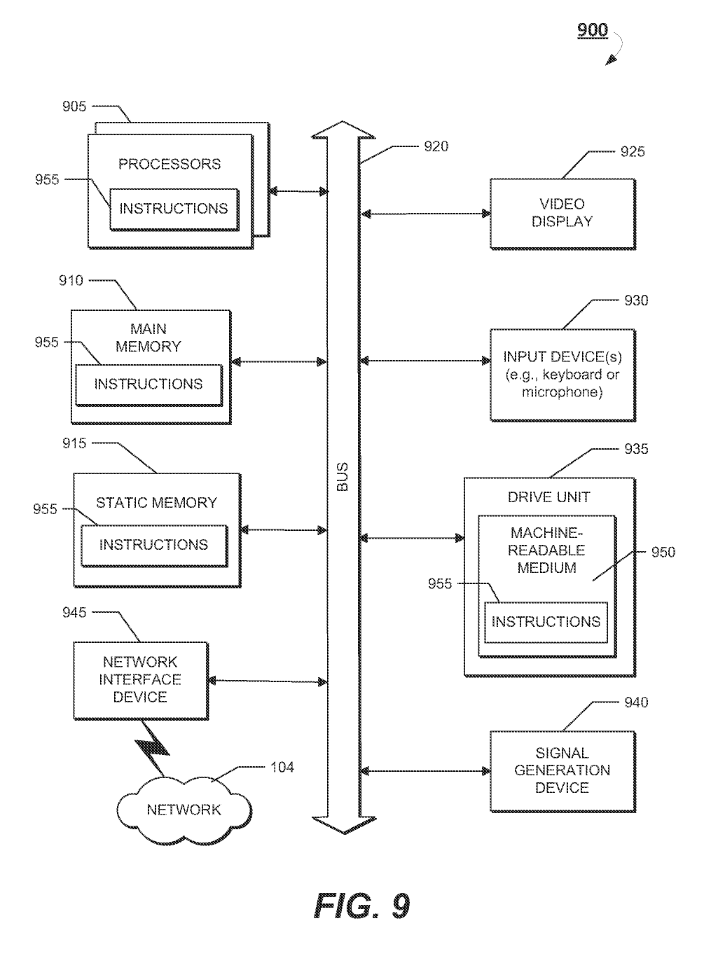

FIG. 9 shows a diagrammatic representation of a computing device for a machine in the example electronic form of a computer system 900, within which a set of instructions for causing the machine to perform any one or more of the methodologies discussed herein can be executed. In various example embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a PDA , a cellular telephone, a portable music player (e.g., a portable hard drive audio device, such as an Moving Picture Experts Group Audio Layer 3 (MP3) player), gaming pad, portable gaming console, in-vehicle computer, infotainment system, smart-home computer, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor or multiple processors 905 (e.g., a central processing unit (CPU), a graphics processing unit (GPU), or both), and a main memory 910 and a static memory 915, which communicate with each other via a bus 920. The computer system 900 can further include a video display unit 925 (e.g., a liquid crystal display (LCD) or a cathode ray tube (CRT)). The computer system 900 also includes at least one input device 930, such as an alphanumeric input device (e.g., a keyboard), a cursor control device (e.g., a mouse), a microphone, a digital camera, a video camera, and so forth. The computer system 900 also includes a disk drive unit 935, a signal generation device 940 (e.g., a speaker), and a network interface device 945.

The disk drive unit 935 includes a computer-readable medium 950, which stores one or more sets of instructions and data structures (e.g., instructions 955) embodying or utilized by any one or more of the methodologies or functions described herein. The instructions 955 can also reside, completely or at least partially, within the main memory 910 and/or within the processors 905 during execution thereof by the computer system 900. The main memory 910 and the processors 905 also constitute machine-readable media.

The instructions 955 can further be transmitted or received over the network 104 via the network interface device 945 utilizing any one of a number of well-known transfer protocols (e.g., Hyper Text Transfer Protocol (HTTP), CAN, Serial, and Modbus).

While the computer-readable medium 950 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, flash memory cards, digital video disks (DVDs), random access memory (RAM), read only memory (ROM), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

Thus, methods and systems for capturing information-enhanced images involving still images associated with high quality audio data are disclosed. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A method for associating media content, the method comprising:
receiving, by a processor, image data associated with an image captured by a camera;
receiving, by the processor, sound data associated with an audio signal captured by a microphone;
applying, by the processor, at least a portion of the sound data to a sound recognition application to automatically determine whether the sound data is representative of a known sound or melody; and
based on the determination, associating, by the processor, the image data with data representative of the known sound or melody.

2. The method of claim 1, further comprising:
receiving, by the processor, audio content corresponding to the data representative of the known sound or melody; and
associating, by the processor, the image, and the audio content.

3. The method of claim 2, further comprising presenting the associated image and audio content to a user via a graphical interface in response to a user input.

4. The method of claim 1, wherein the sound recognition application comprises a music recognition application; and
wherein the method further comprises:
applying, by the processor, at least a portion of the sound data to the music recognition application for the music recognition application to automatically determine whether the sound data is representative of a known musical composition; and
in response to the music recognition application being able to reach a determination that the sound data is representative of a known musical composition, associating, by the processor, the image data with data representative of the known musical composition.

5. The method of claim 4, further comprising storing, in a memory, as part of a data structure, a first data object representative of the image data and a second data object associated with the first data object, wherein the second data object is representative of the known musical composition.

6. The method of claim 5, wherein the data representative of the known musical composition comprises a title for the known musical composition and an artist name for the known musical composition.

7. The method of claim 5, further comprising storing, in the memory, as part of the data structure, a plurality of the first and second data objects, each first data object corresponding to a different image, each second data object corresponding to a known musical composition associated with the image of its associated first data object.

8. The method of claim 5, further comprising posting, in a social network by the processor, the first data object and the second data object in response to a user input.

9. The method of claim 5, further comprising enabling, by the processor, the user to purchase a copy of the known musical composition from a music selling application in response to a user input.

10. The method of claim 9, further comprising storing the purchased copy in the memory in association with the first data object.

11. The method of claim 1, further comprising enabling, by the processor, a user to edit the image or the image data in response to a user input.

12. The method of claim 1, further comprising providing, by the processor, a graphical user interface enabling the user to capture the image with the camera, wherein the camera is integrated into a portable computing device.

13. The method of claim 1, further comprising providing, by the processor, a graphical user interface enabling the user to capture the audio signal with the microphone, wherein the microphone is integrated into a portable computing device.

14. The method of claim 1, wherein the image data includes at least one file name or an identification number of the image; and
wherein the sound data includes at least one file name or an identification number of the audio signal.

15. A system for associating media content, the system comprising:
a communication module configured to receive image data associated with an image captured by a camera, and an audio signal captured by a microphone;
a processor operatively coupled with a memory, wherein the processor is configured to run a sound recognition application to automatically determine whether the audio signal is representative of a known sound or melody based at least in a portion of the sound data;
the processor is further configured to associate the image data with data representative of the known sound or melody based on the determination that the sound data is representative of the known sound or melody.

16. The system of claim 15, wherein the sound recognition application is configured to perform identification that the audio signal is associated with the known song or melody using one or more acoustic fingerprints.

17. The system of claim 15, wherein the sound recognition application is further configured to apply at least a portion of the audio signal to a remote music recognition application to automatically determine whether the audio signal is representative of a known musical composition by (1) communicating at least a portion of the audio signal to the remote music recognition application via a network, and (2) receiving data from the remote music recognition application via the network, wherein the received data is indicative of whether the audio signal is representative of a known musical composition.

18. The system of claim 17, wherein the processor is further configured to, in response to the remote music recognition application being unable to reach a determination that the sound data is representative of a known musical composition, (1) present a graphical user interface, wherein the graphical user interface is configured to solicit input from a user that is representative of information about the audio signal, (2) receive the solicited input via the graphical user interface, and (3) associate the image data with the received solicited input.

19. The system of claim 15, wherein the sound recognition application comprises a music recognition application; and
wherein the sound recognition application is configured to (1) apply at least a portion of the audio signal to the music recognition application for the music recognition application to automatically determine whether the audio signal is representative of a known musical composition, and (2) in response to the music recognition application being able to reach a determination that the audio signal is representative of a known musical composition, associate the image data with data representative of the known musical composition.

20. A non-transitory processor-readable medium having instructions stored thereon, which when executed by one or more processors, cause the one or more processors to implement a method for associating media content, the method comprising:
receiving image data associated with an image captured by a camera;
receiving sound data associated with an audio signal captured by a microphone;
applying at least a portion of the sound data to a sound recognition application to automatically determine whether the sound data is representative of a known sound or melody; and
based on the determination, associating, by the processor, the image data with data representative of the known sound or melody.
